(19) United States
(12) Patent Application Publication
(10) Pub. No.: US 2003/0086418 A1
(43) Pub. Date: May 8, 2003

(54) Intelligent private 3G network and method of operating the same

(76) Inventors: Chris P. McIntosh, San Francisco, CA (US); Priscilla Marilyn Lu, San Carlos, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/068,655

(22) Filed: Feb. 6, 2002

Related U.S. Application Data
(60) Provisional application No. 60/337,034, filed on Nov. 6, 2001.

(51) Int. Cl. H04L 12/66; H04Q 7/20

(52) U.S. Cl. 370/356; 455/433

(57) ABSTRACT

A communication system (100) and method of operating the same to direct packet-switched communications from a User Equipment terminal (UE 138) to a public gateway support node (GSN 112) over a public Iu-PS link (130), or to a community GSN (142) over a private Iu-PS link (146), based on criteria selected, inter alia, to optimize call routing. In one embodiment, the system (100) includes a private home location registry (HLR 148) and a Private Iu Link Intelligent Multiplexing Function (PIuLIM Function 150) configured to direct communications based on information therein. The routing may also be based on a function, supplementary service or specialized application requested by the UE (138). The PIuLIM Function (150) can be included within a radio network controller (134), which is then coupled to the public GSN (112) over the public Iu-PS link (130). Alternatively, the PIuLIM Function (150) can be included within the community GSN (142), and the community GSN coupled to the public GSN (112).

### REFERENCE TO RELATED APPLICATIONS

This application claims priority to U.S. Provisional Application Serial No. 60/337,034, (attorney docket number P-71109) entitled Intelligent private 3G Network and Method of Operating the Same, filed Nov. 6, 2001, which is incorporated herein by reference.

### FIELD

The present invention relates generally to telecommunication systems, and more particularly to an apparatus and method for directing and routing packet-switched communications in a third generation (3G) communication system over either a public or private Iu-PS link.

### BACKGROUND

A standard 3G communication system 10 includes a radio access network (RAN 12), a packet-switched interface or Iu-PS 14 for communicating with a gateway support node (GSN 16) of a packet-switched network 18, such as the Internet, a circuit-switched interface or Iu-CS 20 for communicating with a third generation mobile services switching center (3G-MSC 22) of a circuit-switched network 24, such as the PSTN, and a public home location registry (HLR 25) for recording forwarding addresses of mobile communication system subscribers. Typically, the RAN 12 includes a Radio Network Controller (RNC 26) for communicating between the public or core network and mobile stations 28 through a number of base stations or Node Bs 30.

The 3G communication system described above has a number of problems or shortcomings. Chief among these is the fact that all communications, whether or not originating from a private 3G wireless network must be connected to the packet-switched network 18 through the public GSN 16. This in turn leads to a number of disadvantages including: an inability to maintain ownership or control of information/data transferred between a private 3G wireless network and a packet-switched network; inability to utilize local switching to optimize call routing based on subscriber and/or endpoint information, thereby resulting in excessive or unnecessary backhauling of communications and an inefficient use of system resources.

Accordingly, there is a need for an apparatus and method for routing calls to and from a private wireless network to a packet-switched network of a 3G communication system through a private Iu-PS link. There is a further need for an apparatus and method enabling the private wireless network to maintain ownership of information and data transfer between a private 3G wireless network and a packet-switched network. There is a still further need for an apparatus and method capable of providing improved efficiency in use of system resources through reduction or elimination of backhauling.

The system and method of the present invention provide solutions to these problems and provides other advantages over the prior art.

### SUMMARY

It is an object of the present invention to provide a method and apparatus for directing packet-switched communications to either a public gateway support node over a public Iu-PS link or to a community gateway support node over a private Iu-PS link, based on predetermined criteria selected, inter alia, to optimize call routing.

In one aspect the invention is directed to a communication system including a public packet-switched network, a private network with a community gateway support node (community GSN), and a multiplexing means for directing communications from a number of User Equipment terminals (UEs) to the public network over a public Iu-PS link or to the community GSN over a private Iu-PS link. Generally, the private network includes a radio network controller (RNC) coupled to the community GSN through the private Iu-PS link, and a Node B coupled to the RNC for communicating with the UEs. In a preferred embodiment, the multiplexing means includes a Private Iu Link Intelligent Multiplexing function (PIuLIM Function) configured to direct packet-switched communications to the public GSN over the public Iu-PS link or to the community GSN over the private Iu-PS link based on predetermined criteria. More preferably, the private network is adapted to provide additional services to UEs such as enhanced or unique billing services, supplementary services and support for specialized applications. Optionally, the public network further includes a circuit-switched network with a third generation mobile services switching center (3G-MSC), and the private network is also coupled to the 3G-MSC over an Iu-CS link.

In one embodiment, the PIuLIM Function is included within or part of the RNC, and the RNC is coupled to the public GSN over the public Iu-PS link. Alternatively, the PIuLIM Function can be included within the community GSN, and the community GSN is coupled to the public GSN over the public Iu-PS link.

In another embodiment, the private network further includes a private home location registry (private HLR) coupled to the community GSN, and the predetermined criteria includes subscriber information stored in the private HLR. In one version of this embodiment, the private HLR is a virtual HLR including a number of HLRs or databases at multiple sites which are linked together. Alternatively, a single private HLR may be linked to and shared by a number of community GSNs.

In yet another embodiment, the PIuLIM Function configured to direct packet-switched communications based on a functional or hardware requirements of the UE associated with a particular packet-switched communication. For example, certain quality of service (QoS) requirements and/or streaming requirements, such as multimedia streaming requirements. The PIuLIM Function can also be configured to direct packet-switched communications based on a supplementary service requested by the UE, or based on a specialized application requested by the UE associated with a particular packet-switched communication. Supplementary services can include operations such as providing unstructured supplementary service data (USSD), call forwarding, call transferring or call conferencing between UEs or between a UE and a public or private mobile station, terminal or telephone (not shown). Specialized applications can include applications not supported by the private network such as macro network based multimedia services. Specialized applications can also include applications supported solely by the private network such as voice e-mail.

In another aspect, the invention is directed to a method of operating the private network to communicate with the UEs. Generally, the method includes the steps of: (i) receiving call information from one of the UEs in the PIuLIM Function; (ii) determining whether to couple the UE to the community GSN over a private Iu-PS link, or to the public GSN over a public Iu-PS link; and (iii) coupling the UE to the community GSN over the private Iu-PS link or to the public GSN over the public Iu-PS link. Optionally, wherein the public network further includes a circuit-switched network with a 3G-MSC coupled to the private network over an Iu-CS link, and the method further includes the step of, prior to the step of determining whether to couple the UE to the community GSN or to the public GSN, determining whether the communication is packet-switched or circuit-switched.

In one embodiment, the private network includes a private HLR, and the step of determining whether to couple the UE to the community GSN or to the public GSN can include the step of determining whether subscriber information associated with the UE is stored in the private HLR. Alternatively, the step of determining whether to couple the UE to the community GSN or to the public GSN can be based on a function, a supplementary service or a specialized application required or requested by the UE.

Advantages of the apparatus and method of the present invention include any or all of the following:

(i) ability to call to and from a private 3G wireless network to a packet-switched network through a public or private-community GSN;

(ii) ability to utilize local switching to optimize call routing based on subscriber and/or endpoint information;

(iii) ability to maintain ownership of information/data transfer between a private 3G wireless network and a packet-switched network;

(iv) improved efficiency in use of system resources through reduction or elimination in backhauling of communication path;

(v) ability to provide unique billing and record keeping service for subscribers of the private-community based system; and

(vi) ability to provide additional unique services for subscribers of the private-community based system.

### BRIEF DESCRIPTION OF THE FIGURES

These and various other features and advantages of the present invention will be apparent upon reading of the following detailed description in conjunction with the accompanying drawings, where:

FIG. 1 (prior art) is an exemplary block diagram of a standard 3G communication system including a packet-switched network and a circuit-switched network;

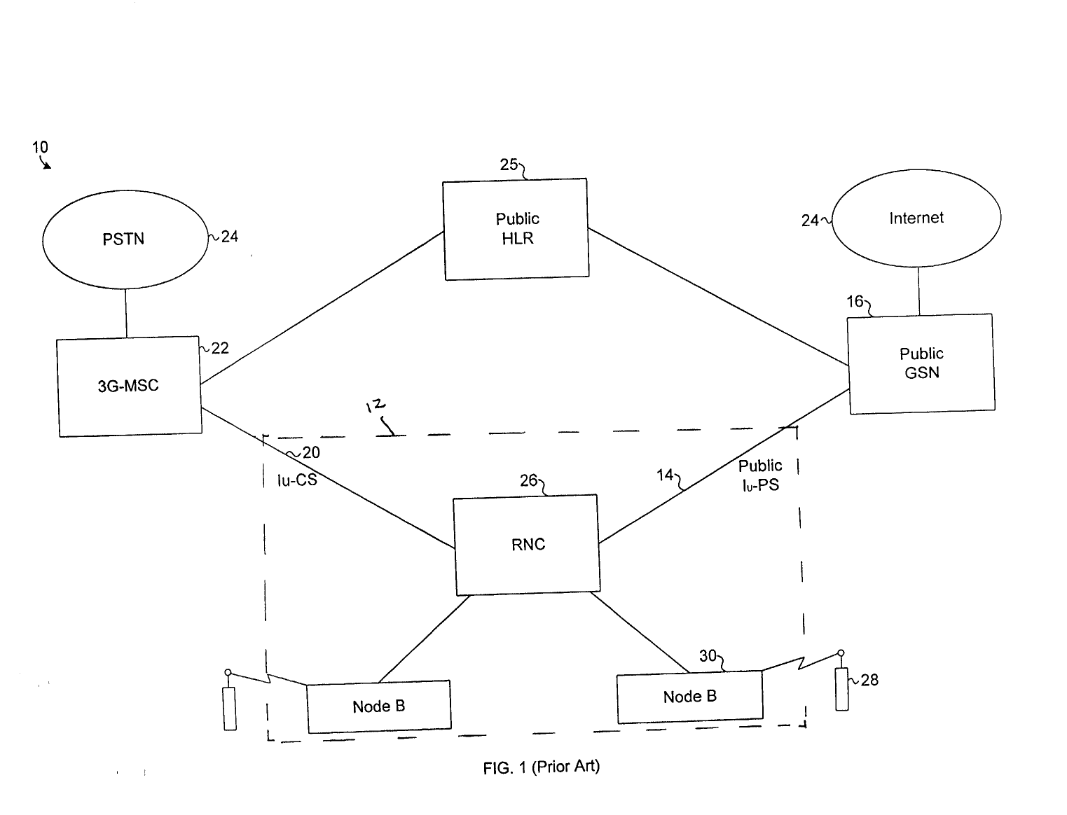

FIG. 2 is a block diagram of an intelligent private 3G communication system having a community gateway support node (GSN) and a Private Iu Link Intelligent Multiplexer (PIuLIM) function according to an embodiment of the present invention;

FIG. 3 is a block diagram of an intelligent private 3G communication system having a GSN and a PIuLIM function according to another embodiment of the present invention;

FIG. 4 is a flowchart showing an embodiment of a process for determining whether a communication should be routed over a public Iu-PS or a private Iu-PS; and

FIG. 5 is a flowchart showing an embodiment of a process for operating an intelligent private 3G communication system to provide communication over a private Iu-PS link according to an embodiment of the present invention.

### DETAILED DESCRIPTION

The present invention is directed to an intelligent private 3G communication system including a packet-switched interface and circuit-switched interface, and an apparatus and method for directing and routing communications to the packet-switched network over either a public or private Iu-PS.

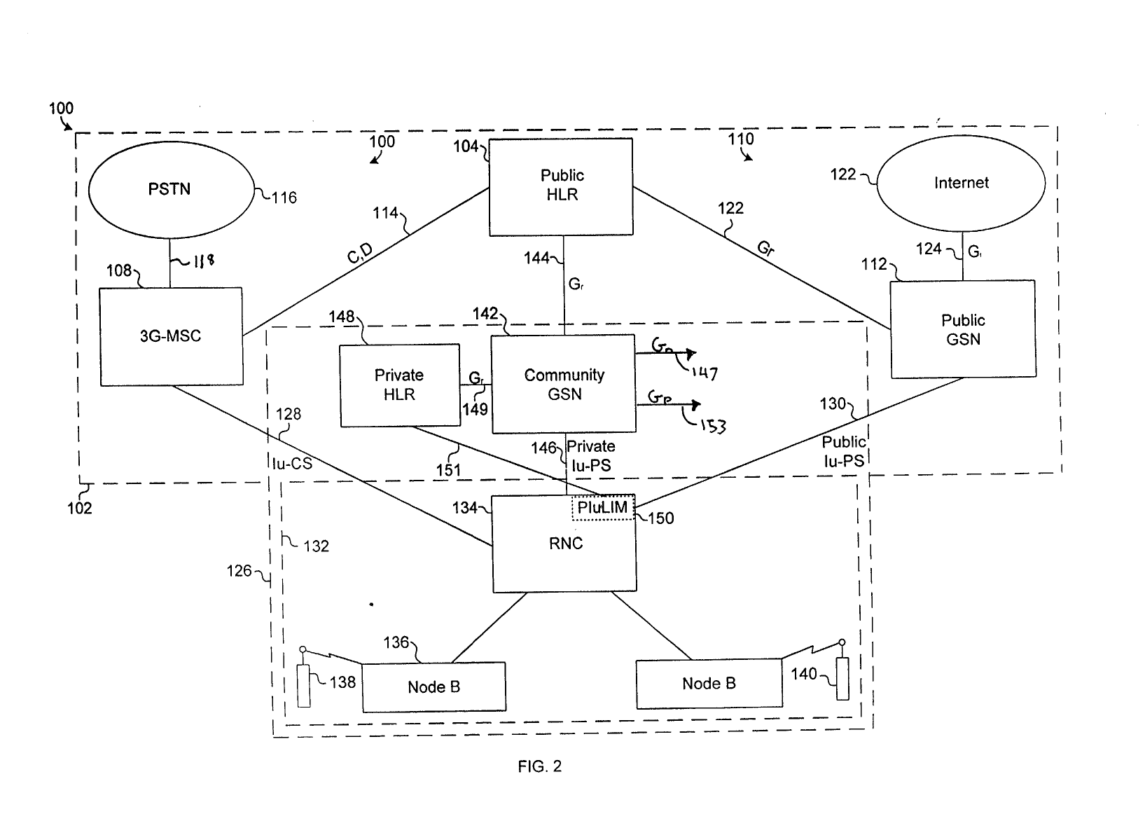

A communication system according to the present invention will now be described with reference to FIG. 2. FIG. 2 is an exemplary block diagram of an intelligent private 3G communication system including a packet-switched interface and circuit-switched interface according to an embodiment of the present invention. For purposes of clarity, many of the details of communication systems and in particular of public circuit-switched networks and public packet-switched networks that are widely known and are not relevant to the present invention have been omitted.

Referring to FIG. 2, the communication system 100 generally comprises a public core network or public network 102 having a public home location registry (public HLR 104) for recording and storing information relating to communication system users or subscribers. The public network 102 also includes a circuit-switched network 106 with a third generation mobile services switching center (3G-MSC 108) and a packet-switched network 110 with a public gateway general packet radio service (GPRS) support node or a public gateway support node (public GSN 112). The 3G-MSC 108 is coupled to the public HLR 104 through a C,D link 114 or interface and to a Public Switched Telephone Network (PSTN 116) through a trunk interface or trunk 118, such as an E1 or T1 trunk. The public GSN 112 is coupled to the public HLR 104 through a Gᵣ link 120 or interface and to an internet protocol network, such as the Internet 122, through a Gᵢ link 124 or interface.

The communication system 100 further includes a private network 126 coupled to the circuit-switched network 106 of the public network 102 through a public Iu-CS or Iu-CS link 128 or interface, and to the packet-switched network 110 through a public Iu-PS link 130 or interface. Generally, the private network 126 includes a private 3G wireless network or Radio Access Network 132 having a controller such as a radio network controller (RNC 134) with at least one transceiver or Node B 136 coupled thereto for communicating with a number of User Equipment terminals (UEs 138, 140).

In accordance with the present invention, the private network 126 further includes a private or community GSN 142 coupled to the public HLR 104 through a Gᵣ link 144 and to the RNC 134 through or over a private Iu-PS link 146 or interface. The community GSN 142 can be linked to other community GSNs (not shown) through a Gn interface or link 147, or by a Gi link (not shown) through an internet protocol (IP) network, such as the Internet or by a private IP network, for example, a wide area network or local area network, to provide a geographically distributed or expanded private network (not shown). The community GSN 142 can be linked to other community GGSN (not shown) in other PLMNs through a Gp link 153. This last embodiment is particularly useful for situations in which it is necessary or desirable to link communities networks in different countries or areas served by different public wireless network providers. Optionally, the private network 126 further includes a private home location registry (private HLR 148) coupled to the community GSN 142 through a Gᵣ link 149. The private HLR 148 records and stores information related to users or subscribers of the private network 126. In one version, the private HLR 148 is a virtual HLR including a number of HLRs or databases at multiple sites, which may or may not be geographically separated, and which are linked together to form the virtual HLR. Alternatively, the private HLR 148 can be a single dedicated HLR which is linked to and shared by a number of other community GSNs in the expanded private network described above.

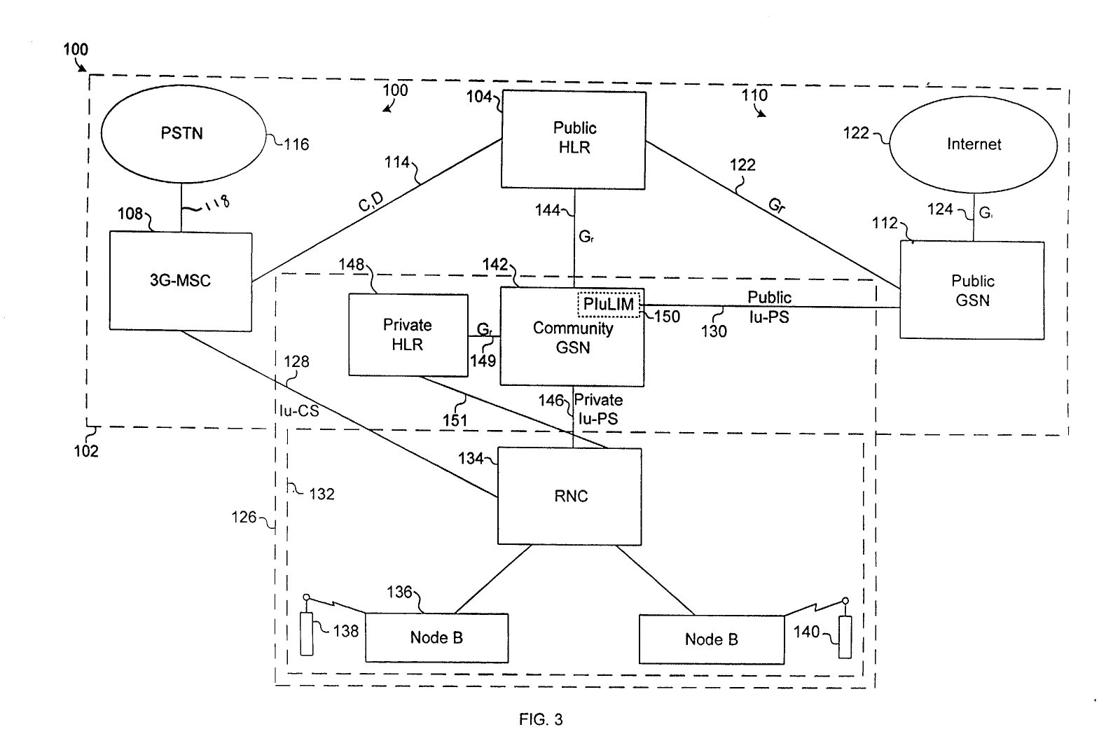

A Private Iu Link Intelligent Multiplexer (PIuLIM) function 150 directs packet-switched communications to either the public GSN 112 or to the community GSN 142. Generally, the PIuLIM function 150 comprises a computer program or software including program code adapted to direct or route packet-switched communications to either the public GSN 112 or to the community GSN 142 based on predetermined criteria. Directing or routing packet-switched communications to the community GSN 142 whenever possible improves efficiency in utilization of communication system resources, reduces toll charges for subscribers to the private network 126, and allows subscribers to the private network to maintain ownership and control of information transferred between UEs 138, 140, in the private network. As shown in FIG. 2, the PIuLIM Function 150 can be included within or part of the RNC 134, and the RNC coupled to the public GSN 112 over the public Iu-PS link 130. Alternatively, the PIuLIM Function 150 can be included within the community GSN 142, and the community GSN coupled to the public GSN 112 over the public Iu-PS link 130, as shown in FIG. 3.

In one embodiment, the predetermined criteria include user or subscriber information stored in the private HLR 148, and the PIuLIM Function 150 is configured to direct packet-switched communications to the public GSN 112 or community GSN 142 based on information in the private HLR. Information stored in the private HLR 138 can include information such as names, phone numbers, authorization, billing information for private subscribers or users associated with the UEs 138, 140, making or receiving the communication. The PIuLIM Function 150 can access or receive information from the private HLR 148 through the community GSN 142, or, in the embodiment in which the PIuLIM Function resides within the RNC 134, directly from the private HLR over a Gᵣ link 151 or interface.

In another embodiment, the predetermined criteria include functions or hardware requirements of a particular UE 138, 140, and the PIuLIM Function 150 is configured to direct packet-switched communications to the public GSN 112 or community GSN 142 based on these requirements. Functions and hardware requirements of the UE 138, 140, which may necessitate routing the communication over the public Iu-PS 130 can include, for example, certain quality of service (QoS) requirements and/or streaming requirements, such as multimedia streaming requirements.

In yet another embodiment, the predetermined criteria include features, or applications requested by a party to a communication. For example, if a feature or application requested by a user of a UE 138, 140, or a mobile station or terminal is not supported by the private network 126, the PIuLIM function 150 is adapted to route communication to the public GSN 112. This routing occurs independently of whether the user is registered as a private subscriber in the private HLR 148, and/or whether the communication might otherwise be routed more efficiently or at a lower cost through the community GSN 142.

Typically, the determination to route the communication over the public GSN 112 or the community GSN 142 is executed automatically in a seamless manner that is substantially transport to all users or parties to the communication. However, optionally a response or signaling circuit (not shown) can be used to alert either or both users or parties of the routing used.

Preferably, either or both of the private HLR 148 and the community GSN 126 are adapted to provide or support (i) unique billing services; (ii) supplementary services; or (iii) specialized applications, for UEs 138, 140, coupled over the private Iu-PS link through the community GSN 126. Billing services provided can include, for example, billing according to: destination; packet content; peak or off-peak use; QoS required or provided; user location; number of packets transmitted; throughput or baud rate required; and packet duration or duration. By supplementary services it is meant services such as forwarding, transferring or conferencing a call between two UEs 138, 140, or between a UE and a mobile station or telephone (not shown) connected over the public network 102. Specialized applications can include applications such as e-mail integration, location based services, etc.

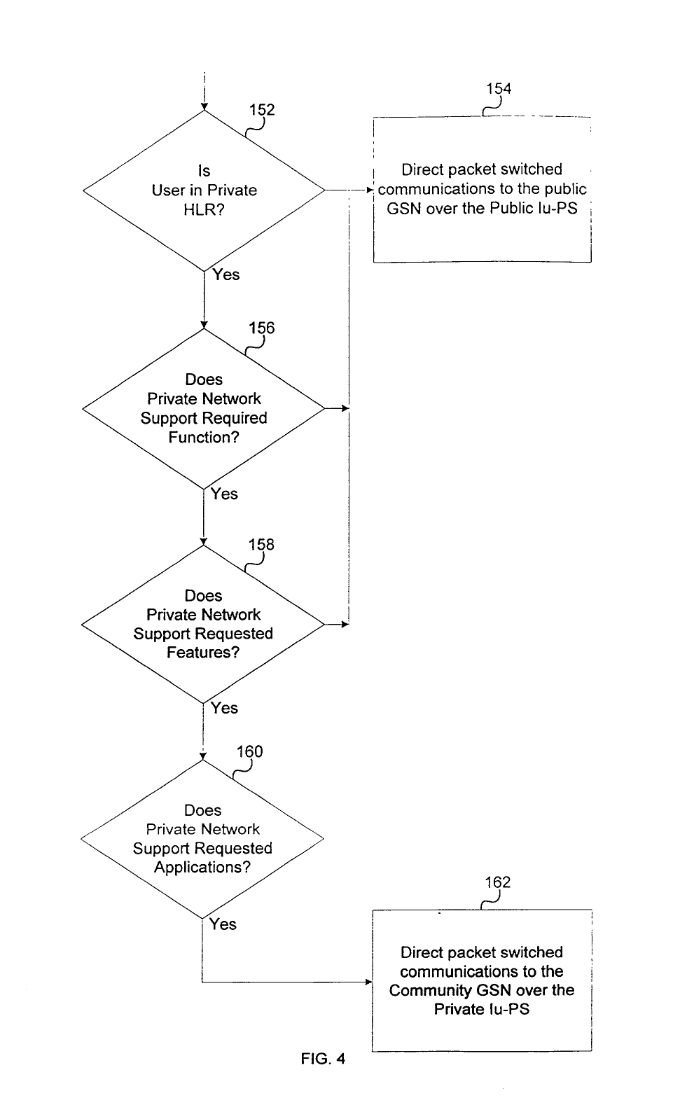

A method or process for determining whether to route or direct packet-switched communication over the private Iu-PS link 146 will now be described with reference to FIG. 4. FIG. 4 is a flowchart showing an embodiment of a process for determining whether a communication should be routed over a public Iu-PS 130 or a private Iu-PS 146. In a first step, a determination is made whether the user or subscriber information associated with the UE 138 is stored in Private HLR 148 (step 152). If the user or subscriber information is not found in Private HLR 148, the packet-switched communication is directed to the public GSN 112 over the Public Iu-PS 130 (step 154). If the information is found in Private HLR 148, a determination is made whether the private network 126 supports all function and hardware requirements of the UE 138 (step 156). If not, the communication is directed over the Public Iu-PS 130. If the private network 126 supports the function and hardware requirements of the UE 138, a determination is made as to whether the private network supports all features requested by the UE (step 158). If not, the communication is directed over the Public Iu-PS 130. If the features requested are supported, a determination is made as to whether the private network 126 supports all applications requested by the UE 138 (step 160). If not, the communication is directed over the Public Iu-PS 130. If the applications requested are supported, the packet-switched communications are directed to the community GSN 142 over the Private Iu-PS 146 (step 162).

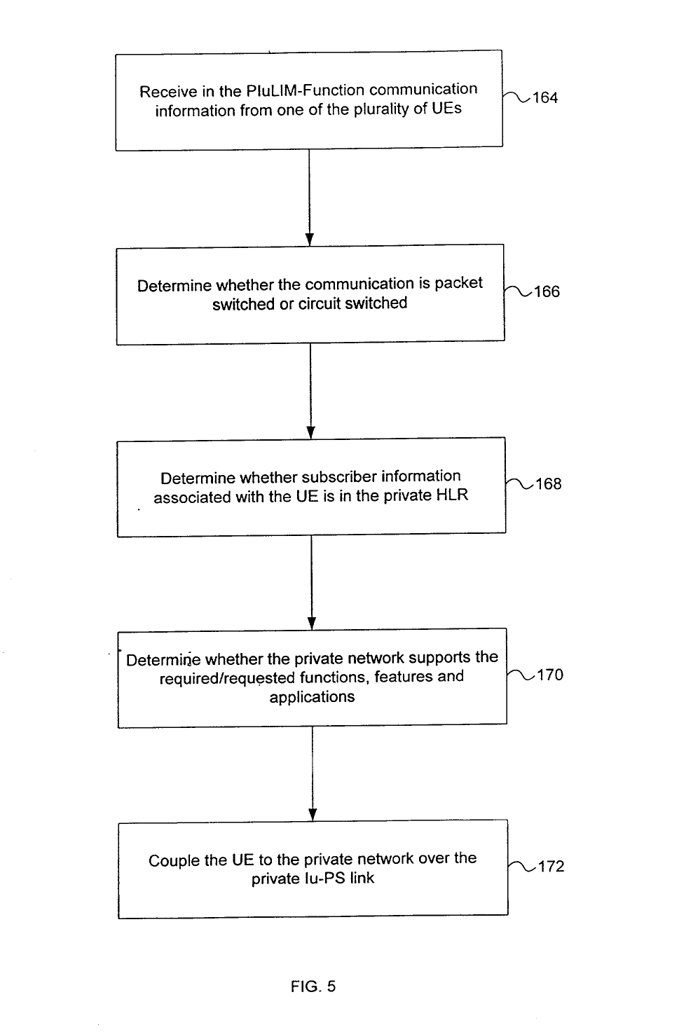

A method or process for operating the communication system according to an embodiment of the present invention will now be described with reference to FIG. 5. FIG. 5 is a flowchart showing an embodiment of a process for operating the communication system 100 to provide communication over the private Iu-PS link 146. In the method, the PIuLIM-Function 150 receives communication information from a UE 138 (step 164). A determination is made whether the communication is packet-switched or circuit-switched (step 166). The PIuLIM-Function 150 checks the private HLR 148 to learn whether subscriber information associated with the UE 138 is stored therein (step 168). A determination is made in the PIuLIM-Function 150 whether the private network 126 supports the required and/or requested functions, features and applications (step 170). The PIuLIM-Function 150 then couples the UE 138 to the community GSN 142 over the private Iu-PS link 146 (step 172).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best use the invention and various embodiments with various modifications as are suited to the particular use contemplated. It is intended that the scope of the invention be defined by the claims appended hereto and their equivalents.

We claim:

1. A communication system comprising:
a public network having a packet-switched network with a public gateway support node (public GSN); and
a private network coupled to the public GSN over a public Iu-PS link, the private network having:
a community gateway support node (community GSN);
a radio network controller (RNC) coupled to the community GSN through a private Iu-PS link;
at least one Node B coupled to the RNC for communicating with a plurality of User Equipment terminals (UEs);
a Private Iu Link Intelligent Multiplexing function (PIuLIM Function) configured to direct packet-switched communications to the public GSN over the public Iu-PS link or to the community GSN over the private Iu-PS link.

2. A communication system according to claim 1, wherein the private network further comprises a private home location registry (private HLR) coupled to the community GSN.

3. A communication system according to claim 2, wherein the PIuLIM Function is configured to direct packet-switched communications based on information stored in the private HLR.

4. A communication system according to claim 2, wherein the private HLR is a virtual HLR comprising a plurality of HLRs at multiple sites which are linked together.

5. A communication system according to claim 2, wherein the private HLR is linked to a plurality of community GSNs.

6. A communication system according to claim 1, wherein the PIuLIM Function configured to direct packet-switched communications based on a function required by the UE associated with a particular packet-switched communication.

7. A communication system according to claim 1, wherein the PIuLIM Function configured to direct packet-switched communications based on a supplementary service requested by the UE associated with a particular packet-switched communication.

8. A communication system according to claim 1, wherein the PIuLIM Function configured to direct packet-switched communications based on a specialized application requested by the UE associated with a particular packet-switched communication.

9. A communication system according to claim 1, wherein the private network is adapted to provide additional services to UEs selected from the group consisting of:
billing services;
supplementary services; and
support for specialized applications.

10. A communication system according to claim 1, wherein the RNC comprises the PIuLIM Function, and wherein the RNC is coupled to the public GSN over the public Iu-PS link.

11. A communication system according to claim 1, wherein the community GSN comprises the PIuLIM Function, and wherein the community GSN is coupled to the public GSN over the public Iu-PS link.

12. A communication system according to claim 1, wherein the public network further comprises a circuit-switched network with a third generation mobile services switching center (3G-MSC), and wherein the private network is coupled to the 3G-MSC over an Iu-CS link.

13. In a communication system having a public network with a public gateway support node (public GSN), and a private network with a community GSN, a Radio Network Controller (RNC) and at least one Node B coupled to the RNC for communicating with a plurality of User Equipment terminals (UEs), a method of operating the private network to communicate with the UEs, the method comprising steps of:
receiving in a Private Iu Link Intelligent Multiplexing function (PIuLIM Function) in the private network communication information from one of the plurality of UEs;
determining whether to couple the UE to the community GSN over a private Iu-PS link, or to the public GSN over a public Iu-PS link; and
coupling the UE to the community GSN over the private Iu-PS link or to the public GSN over the public Iu-PS link.

14. A method according to claim 13, wherein the private network further comprises a private home location registry (private HLR), and wherein the step of determining whether to couple the UE to the community GSN or to the public GSN comprises the step of determining whether subscriber information associated with the UE is stored in the private HLR.

15. A method according to claim 13, wherein the step of determining whether to couple the UE to the community GSN or to the public GSN comprises the step of determining whether to couple the UE to the community GSN or to the public GSN based on a function required by the UE.

16. A method according to claim 13, wherein the step of determining whether to couple the UE to the community GSN or to the public GSN comprises the step of determining whether to couple the UE to the community GSN or to the public GSN based on a supplementary service requested by the UE.

17. A method according to claim 13, wherein the step of determining whether to couple the UE to the community GSN or to the public GSN comprises the step of determining whether to couple the UE to the community GSN or to the public GSN based on a specialized application requested by the UE.

18. A method according to claim 13, wherein the public network further comprises a circuit-switched network with a third generation mobile services switching center (3G-MSC) coupled to the private network over an Iu-CS link, and wherein the method further comprises the step of, prior to the step of determining whether to couple the UE to the community GSN or to the public GSN, determining whether the communication is packet-switched or circuit-switched.

19. A communication system comprising:
a public network having:
a public home location registry (public HLR);
a packet-switched network with a public gateway support node (public GSN) coupled to the Internet and to the public HLR; and
a circuit-switched network with a third generation mobile services switching center (3G-MSC) coupled to a Public Switched Telephone Network (PSTN) and to the public HLR; and
a private network coupled to the public GSN over a public Iu-PS link and to the 3G-MSC over an Iu-CS link, the private network having:
a community gateway support node (community GSN) coupled to the public HLR;
a private home location registry (private HLR) coupled to the community GSN;
a radio access network (RAN) with a radio network controller (RNC) coupled to the community GSN through a private Iu-PS link, and at least one Node B coupled to the RNC for communicating with a plurality of User Equipment terminals (UEs); and
a Private Iu Link Intelligent Multiplexing Function (PIuLIM Function) for directing packet-switched communications to the public GSN over the public Iu-PS link or to the community GSN over the private Iu-PS link, the PIuLIM Function configured to direct packet-switched communications to the public GSN or to the community GSN based on predetermined criteria selected from the group consisting of:
information stored in the private HLR;
a function required by the UE;
a supplementary service requested by the UE; and
an application requested by the UE.

20. A communication system comprising:
a public network having a packet-switched network; and
a private network coupled to the public network over a public Iu-PS link, the private network having:
a community gateway support node (community GSN) coupled to the public network in the public network;
transceiver means for communicating with a plurality of User Equipment terminals (UEs);
control means for controlling the transceiver means, the control means coupled to the transceiver means and to the community GSN through a private Iu-PS link; and
multiplexing means for directing communications with the plurality of UEs to the public network over the public Iu-PS link or to the community GSN over the private Iu-PS link.

21. A communication system according to claim 20, wherein the community GSN comprises the multiplexing means, and wherein the community GSN is coupled to the public GSN over the public Iu-PS link.
